(19) United States
(12) Patent Application Publication
(10) Pub. No.: US 2012/0053904 A1
(43) Pub. Date: Mar. 1, 2012

(54) INFORMATION PROCESSING APPARATUS IN OCT SYSTEM

(75) Inventors: Takashi Yuasa, Sagamihara-shi (JP); Mitsuro Sugita, Wien (AT)

(73) Assignee: CANON KABUSHIKI KAISHA, Tokyo (JP)

(21) Appl. No.: 13/266,468

(22) PCT Filed: Mar. 30, 2010
(86) PCT No.: PCT/JP2010/056118

§ 371 Date: Oct. 27, 2011

(30) Foreign Application Priority Data
May 11, 2009 (JP) 2009-114423

(51) Int. Cl. G06F 15/00

(52) U.S. Cl. 702/189

(57) ABSTRACT

Provided is an information processing apparatus in an OCT system capable of acquiring tomographic information and moving velocity information of an object at high speed and over a region larger than a spot size. The apparatus splits light including a plurality of lights of at least first and second light into measurement lights and reference lights and acquires tomographic information and moving velocity information of an object, having: a scanning optical system for scanning with the measurement light; an optical system for applying the measurement light to different spot positions; interference signal generating devices which generate first and second interference signals from a return light obtained when the measurement light is applied to the positions and the reference light reflected by a reference mirror; and a signal processing device which calculates a variation in phase using the interference signals and computes a moving velocity of the object.

### TECHNICAL FIELD

The present invention relates to an information processing apparatus in an OCT system and, more particularly, to an information processing apparatus in an OCT system using a plurality of lights.

### BACKGROUND ART

In recent years, an optical tomographic imaging apparatus (optical coherence tomographic imaging apparatus) to which the technology of low coherence interferometers or white light interferometers is applied has been put to practical use.

Such an apparatus is called an optical coherence tomography (OCT) and is used, particularly in ophthalmology, to obtain tomographic images of a fundus and a retina. Attempts have been made to use the apparatus in tomographic observation of skin and to use the apparatus configured as one of an endoscope and a catheter in capture of tomographic images of wall surfaces of a digestive organ and a cardiovascular organ, in a field other than ophthalmology as well.

Hereinafter, an optical tomographic imaging apparatus using the above-described OCT system will be referred to as an OCT apparatus.

An apparatus called a Doppler OCT apparatus has been developed in recent years. The apparatus can simultaneously measure a phase shift in an interference signal caused by a Doppler shift and acquire flow velocity information of an object (moving velocity information of the object).

U.S. Pat. No. 6,549,801 discloses a Doppler OCT apparatus which, in time-domain OCT apparatuses using a single light, Fourier-transforms each of pieces of spectral information of interfering light acquired at different times and obtains a variation in phase.

The Doppler OCT apparatus adopts the process of obtaining a variation in the phase of an OCT signal by calculating a phase by a Hilbert transformation and calculating a time lag between pieces of tomographic image information in a depth direction (A-scans).

A moving velocity of an object is calculated by using the correspondence of such a variation in phase as a Doppler shift with the moving velocity of the object.

However, a Doppler OCT apparatus using a single light as in U.S. Pat. No. 6,549,801 suffers from the problem of a long measurement time, the difficulty of acquiring shape information and moving velocity information of an object over a region larger than a spot size, and the like.

A Doppler OCT apparatus using a single light obtains a variation in phase in order to obtain a Doppler signal and thus needs to irradiate the same site with a single light at different times by repeated light scans.

At this time, the work of setting the interval between adjacent A-lines to be smaller than a spot size, for example, is required to obtain a plurality of types of information on shape information and moving velocity information of an object from the same site.

For this reason, a Doppler OCT apparatus using a single light requires a long time to measure one tomographic image.

Since a measured region is limited to a range of a spot size, shape information and moving velocity information of an object cannot be acquired over a region larger than the spot size. Accordingly, a Doppler OCT apparatus using a single light is unsuitable for, e.g., use in calculating an average blood flow of the whole of an optic disk of a human eye and its vicinity.

### DISCLOSURE OF THE INVENTION

The present invention has been made in consideration of the above-described problems, and has as its object to provide an information processing apparatus in an OCT system which is capable of acquiring tomographic information and moving velocity information of an object at high speed and enables acquisition of tomographic information and moving velocity information of an object over a region larger than a spot size.

The present invention provides an information processing apparatus in an OCT system configured in the manner below.

The information processing apparatus in the OCT system according to the present invention is an information processing apparatus acquiring tomographic information and moving velocity information of an object comprising:

a scanning optical system for scanning the object with a plurality of lights including at least first and second measurement lights; an optical system which focuses the first and second measurement lights on different spot positions of the object, the first and second measurement lights being scanned same area of the object by the scanning optical system; interference signal generating devices which generate interference signals from return lights reflected or scattered by the object and the reference lights reflected by a reference mirror; and a signal processing device which calculates a variation in phase using the interference signals from different measurement lights and computes a moving velocity of the object based on the variation in phase.

According to the present invention, it is possible to realize an information processing apparatus in an OCT system which is capable of acquiring tomographic information and moving velocity information of an object at high speed and enables acquisition of tomographic information and moving velocity information of an object over a region larger than a spot size.

Further features of the present invention will become apparent from the following description of exemplary embodiments with reference to the attached drawings.

### BRIEF DESCRIPTION OF THE DRAWINGS

FIG. 1 is a diagram for describing the configuration of an information processing apparatus in an OCT system according to an embodiment and a first example of the present invention;

FIG. 2 is a chart for describing processing in a recording section of the information processing apparatus in the OCT system according to the first example of the present invention;

FIG. 3 is a view for describing the relationship between an object and scan lines in the first example of the present invention;

FIGS. 4A, B4, 4C, 4D, 4E, and 4F are charts for describing measurement results in the first example of the present invention;

FIG. 5A is a view for describing a fundus image serving as an object in a second example of the present invention;

FIG. 5B is a view for describing the relationship between the object and scan lines in the second example of the present invention;

FIGS. 6A, 6B, 6C, and 6D are charts for describing measurement results in the second example of the present invention; and

FIG. 7 is a diagram for describing a configuration example of a third example of the present invention.

### BEST MODES FOR CARRYING OUT THE INVENTION

An information processing apparatus in an OCT system which acquires tomographic information and moving velocity information of an object according to an embodiment of the present invention will be described.

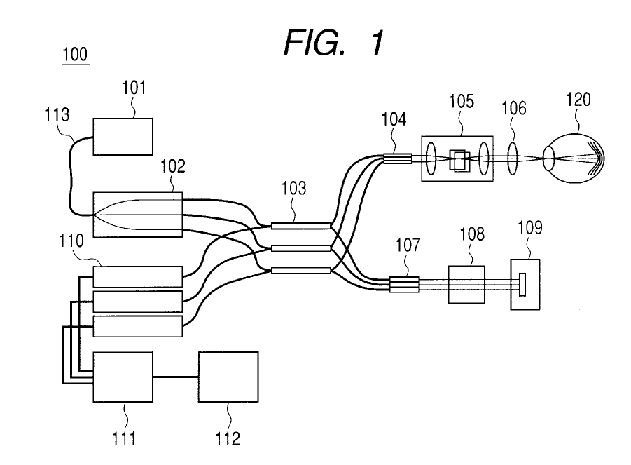

An information processing apparatus in an OCT system according to the present embodiment illustrated in FIG. 1 (hereinafter referred to as an OCT apparatus 100) is configured in the manner below.

In the OCT apparatus 100 according to the present embodiment, light emitted from a low coherence light source 101 passes through an optical fiber 113 and enters a fiber beam splitter 102. The light is split a plurality of light (in the present example, three lights including a first light, a second light, and a third light).

The split lights are further split into measurement lights and reference lights, both of which are made up of the plurality of lights, by fiber couplers 103.

The measurement lights are collimated into equidistant collimated lights by a fiber array collimator 104.

The collimated lights are scanned by a scanning optical system 105 which is made up of a scanner and lenses and are applied to different spot positions of an object 120 by an objective lens 106.

Lights reflected or scattered from the object 120 pass through a light path through which a measurement light passes and return to the fiber coupler 103.

The reference lights are collimated into collimated lights by a fiber collimator 107, are reflected by a reference mirror 109 provided in a reference light path via a dispersion compensation glass 108, and are returned to the fiber coupler 103.

In the fiber couplers 103 (a first interference signal generating device, a second interference signal generating device, and a third interference signal generating device), the reflected or scattered light of the measurement lights are combined with the reference lights to generate interfering lights (first interference signal, second interference signal and third interference signal).

Each interfering light enters a spectroscopic detection section 110 which is made up of a lens, a diffraction grating, and a line sensor camera, is dispersed, and is signal-processed and recorded as digital data in a computer recording section (signal processing device) 111.

The processing flow in the recording section 111 will now be described.

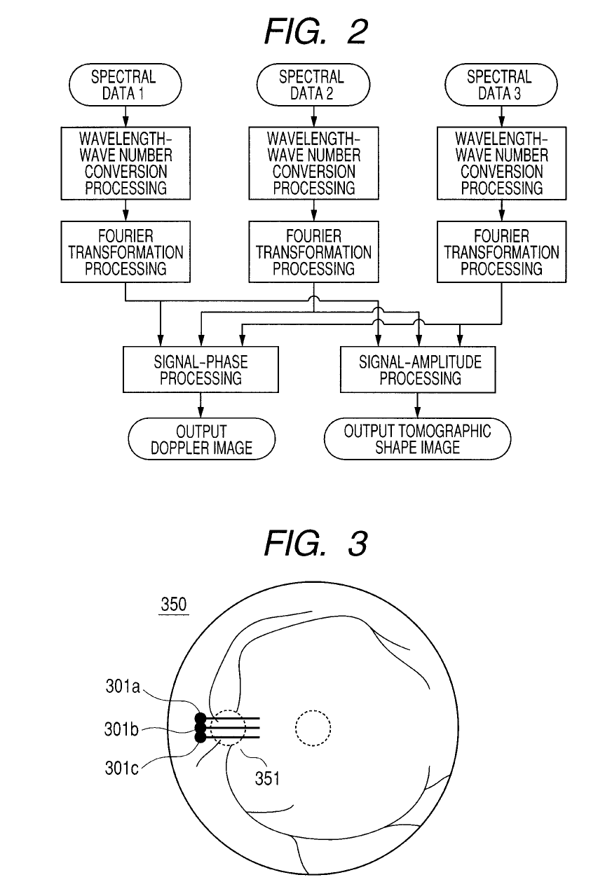

Spectral data (spectral data 1, 2, and 3) generated by the spectroscopic detection sections 110 illustrated in FIG. 2 are each composed of a sequence of data on an interference intensity P(λₙ) at a wavelength λₙ corresponding to an n-th pixel of a line sensor.

Before processing Fourier transformation, the data sequence is converted into a data sequence in a wavenumber space in a wavelength-wavenumber conversion processing step in the recording section 111.

At this time, a sequence of data on the interference intensity Pk(kₙ) is not an equally spaced data sequence in the wavenumber space if simply assuming that kₙ=2Π/λₙ and assuming an interference intensity in the wavenumber space that Pk (kₙ)=P(λₙ). Hence, an interference intensity P_{K}(Kₘ) corresponding to Kₘ, which is an m-th term of an equally spaced wavenumber sequence, is calculated by linear interpolation.

In a Fourier transformation processing step in the recording section 111, a signal having undergone a Fourier transformation according to (Expression 1) below, at depth z and time t, is obtained.

FT[P_{K}(Kⱼ)−Pₛ(Kⱼ)−Pᵣ(Kⱼ)]=A(z,t) exp[iΦ(z,t)] (Expression 1)

In (Expression 1), FT[ ] represents a Fourier transformation, and Pₛ and Pᵣ represent a measurement light intensity and a reference light intensity, respectively. The parameter A(z,t) represents an intensity amplitude. A normal OCT image is constructed using the intensity amplitude A(z,t).

The parameter Φ(z,t) represents a phase. A Doppler shift frequency f_{D}(z,t) is calculated from a temporal difference for the phase Φ(z,t) according to (Expression 2) below.

A flow velocity v(z,t) is calculated according to (Expression 3) below, based on the Doppler shift frequency f_{D} calculated according to (Expression 2).

f_{D}(z,t)=[Φ(z,t+Δt)−Φ(z,t)]/(2ΠΔt) (Expression 2)

v(z,t)=f_{D}(z,t)λ₀/(2n cos θ) (Expression 3)

In (Expression 3), λ_{D} represents the center wavelength of a light source, n represents the refractive index of the object 120, and θ represents an angle which an optical axis forms with the flow velocity.

As described above, Fourier transformations using the different interference signals (the first interference signal, the second interference signal, and the third interference signal) derived from a plurality of lights enable calculation of a variation in phase from a Doppler shift frequency according to (Expression 2) above.

A moving velocity of the object is computed according to (Expression 3) above based on the variation in phase to calculate a flow velocity (the moving velocity of the object). With these operations, it is possible to simultaneously measure a flow velocity (a moving velocity of the object) at a plurality of sites.

Averaging of flow velocities at the sites enables measurement of an average flow velocity (an average moving velocity of the object) over a wide range.

The processing for the signal amplitude A(z,t) and the processing for the signal phase Φ(z,t) described above are performed in a signal amplitude processing step and a signal phase processing step, respectively, and a tomographic shape image and a Doppler image are obtained. The results are displayed on an image display section 112.

As described above, a configuration using a plurality of lights as in the present embodiment is unlike the above-described prior-art example using a single light. The configuration may eliminate the need to irradiate the same site with a single light at different times by repeated light scans in order to obtain a variation in phase.

It is thus possible to acquire tomographic information and moving velocity information of an object at high speed. Note that such an optical tomographic imaging apparatus based on an OCT system according to the present invention includes vital observation of a fundus, skin, observation using, e.g., an endoscope, and industrial quality control and can be used in various types of diagnostic apparatuses and inspection apparatuses.

Embodiments of the present invention will be described in more detail below with reference to the drawings.

### FIRST EXAMPLE

In a first example, an OCT apparatus 100 illustrated in FIG. 1, as in the above embodiment, is used as an information processing apparatus in an OCT system, and a retina 120 of an eye is selected as an object serving as an object to be measured.

An SLD light source with an output power of 20 mW, a center wavelength of 840 nm, and a wavelength width of 45 nm is used as a low coherence light source 101.

Light emitted from the light source is split into three equal light by a ⅓ fiber beam splitter 102.

Each light is separated into a measurement light and a reference light by a corresponding one of three 50/50 fiber couplers 103.

The measurement lights are converted into collimated lights by a fiber collimator 104. The collimated lights are scanned by a scanning optical system 105 which is made up of a galvano scanner and lenses and are converted by an objective lens 106 into collimated lights with a diameter of about 1 mm. The collimated lights enter an eye and are applied to different points on the retina 120 of the eye.

FIG. 3 illustrates a fundus image 350 at the retina 120 according to the present example.

There are three combinations 301a, 301b, and 301c of a spot and a scan line centered on an optic disk 351 on the fundus image 350 of the retina 120. Since the optical system is adjusted such that an incident diameter of the light is about 1 mm, a spot size on the retina is about 20 μm.

In the fiber array collimator 104, the fiber interval is 80 μm, the core diameter is 5 μm, and the number of fibers is 3. The interval between spots is about 320 μm.

The three reference lights are converted into collimated lights by a fiber collimator 107. The collimated lights pass through a dispersion compensation glass 108 and are reflected by a reference mirror 109. The reflected lights are returned to the fiber couplers 103.

Interference signals generated by the three fiber couplers 103 enter three spectroscopic detection sections 110, respectively.

Each spectroscopic detection section 110 is made up of a spectral optical system using a 1,200 lines/mm transmission grating and a line sensor with a pixel pitch of 14 μm, a pixel number of 2,048, and a line rate of 20 kHz. Wavelength spectral data including the interference signals are obtained from the spectroscopic detection sections 110.

The data are recorded as 12-bit digital data in a recording section 111, and signal processing is performed based on the processing flow illustrated in FIG. 2. The results of the signal processing are displayed on an image display section 112. The length of each scan line in FIG. 3 is about 2 mm on the retina.

If A-line measurement is performed within the range 1,024 times, a measurement time interval Δt is 50 μs, a measurement pitch is about 2 μm, and a total measurement time is 51.2 ms.

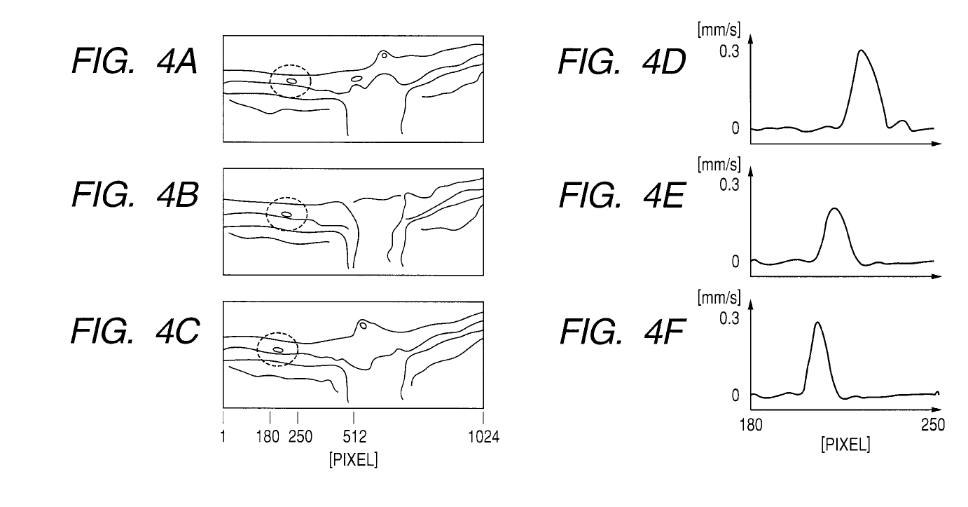

FIGS. 4A, 4B, and 4C illustrate schematic views of OCT images which are the results of processing signals obtained from the above scans according to the method indicated by (Expression 1) above.

FIG. 4A, 4B, and 4C correspond to the light spots 301a, 301b, and 301c, respectively.

FIGS. 4D, 4E, and 4F are each obtained by calculating according to (Expression 2) above a Doppler shift frequency of a part which is enclosed by a broken line in a corresponding FIGS. 4A, 4B, and 4C, respectively, and which seems to be a cross-section of a blood vessel, and calculating according to (Expression 3) a flow velocity v(z,t) from the calculated Doppler shift frequency above while letting λ_{c}=840 nm, n=1.38, and θ=80°.

Note that an average blood flow velocity of the whole optic disc can be calculated by calculating a flow velocity v(z,t) for all areas of the OCT image and averaging the flow velocities, as given by Σv(z,t)/(pixel number).

As described above, according to the present example, use of a plurality of spots enables simultaneous measurement of a Doppler frequency and a flow velocity at different measurement positions. Additionally, averaging measurement results at the spots enables calculation of an average flow velocity over a region larger than a spot size.

Although the case using the three different spots has been described as an example, the present invention is not limited to the case. The same effects can be obtained as long as a plurality of (two or more) different spots are used.

Although the present example has described a method based on a spectral-domain approach, the same effects can be obtained according to a method based on a swept-source approach.

In the case of a time-domain approach, the same effects can be obtained by the process of calculating a phase by a Hilbert transformation and calculating a temporal difference for a phase Φ(z,t) according to (Expression 2).

### SECOND EXAMPLE

A second example will describe a configuration example in which an OCT apparatus as in the first example is used, and light spot positions are shifted from each other in a scan line direction.

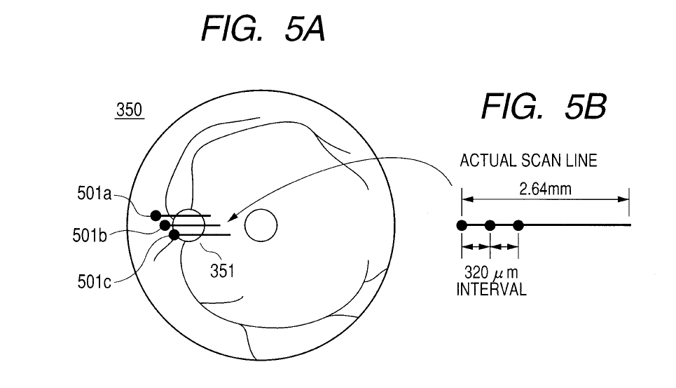

FIG. 5A illustrates a fundus image 350 at a retina 120 according to the present example.

There are three combinations 501a, 501b, and 501c of a spot and a scan line near the center of an optic disc 351 on the fundus image 350.

For clarity, the scan lines are illustrated to be shifted from each other on the fundus image 350 in FIG. 5A. However, the scan lines actually overlap each other, as illustrated in FIG. 5B.

Since an optical system is adjusted such that an incident diameter of the light is about 1 mm, a spot size on a fundus is about 20 μm.

In a fiber collimator 104, the fiber interval is 80 μm, the core diameter is 5 μm, and the number of fibers is 3. The interval between spots is about 320 μm.

In the present example, three spectroscopic detection sections 110 are each made up of a spectral optical system using a 1,200 lines/mm transmission grating and a line sensor with a pixel pitch of 10 μm, a pixel number of 2,048, and a line rate of 70 kHz. Wavelength spectral data including interference signals are obtained from the spectroscopic detection sections 110.

The data are recorded as 12-bit digital data in a recording section 111, and signal processing is performed based on the processing flow illustrated in FIG. 2.

At this time, data for a single light spot is not used alone but is used in combination with data for a different light spot.

More specifically, the light spots 501a, 501b, and 501c pass over a single scan line with a time lag Δt corresponding to the spot interval between each adjacent two. A Doppler frequency in (Expression 2) above is calculated using data sequences shifted from each other by a pixel number corresponding to the time lag.

The length of each scan line in FIGS. 5A and 5B is about 2 mm on the retina.

If A-line measurement is performed within the range for 256 times, a measurement time is about 3.66 ms, a measurement pitch is about 7.8 μm, and the time lag Δt corresponding to the interval of 320 μm between the light spots 501a, 501b, and 501c is about 0.21 ms.

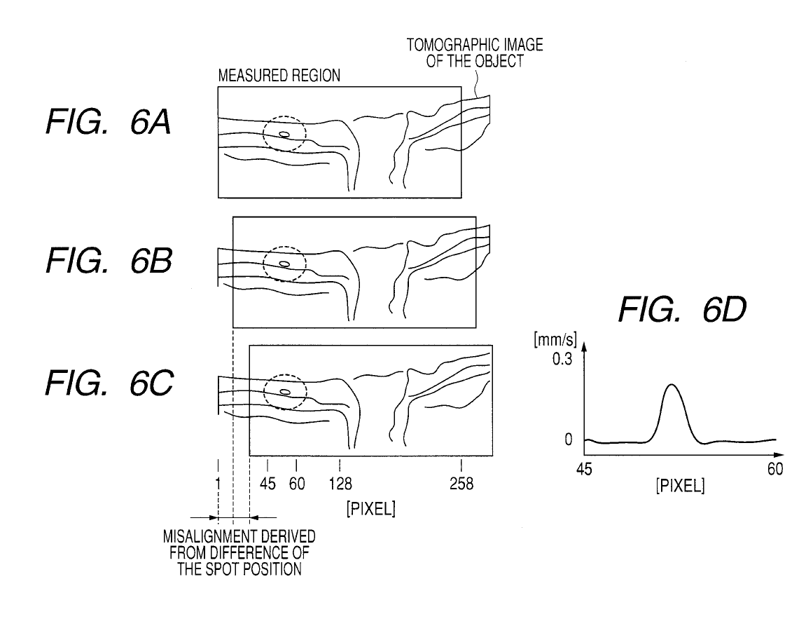

FIGS. 6A, 6B, and 6C illustrate schematic views of OCT images which are the result of processing signals obtained from the above scans according to the method indicated by (Expression 1) above.

FIG. 6A, 6B, and 6C correspond to the light spots 501a, 501b, and 501c, respectively.

A Doppler shift frequency of a part which is enclosed by a broken line in an OCT image and which seems to be a cross-section of a blood vessel is first calculated according to (Expression 2) above between FIGS. 6A and 6B and between FIGS. 6B and 6C.

The calculation results are averaged to calculate a Doppler shift frequency f_{D}(z,t).

FIG. 6D illustrates the result of calculating a flow velocity v(z,t) according to (Expression 3) above while letting λ₀=840 nm, n=1.38, and θ=80°. The same result is obtained by first calculating blood flow velocities and then averaging the blood flow velocities.

According to the method of the present example, the measurement light spots scan the same position, and it is thus possible to perform measurement with a lateral resolution equal to the spot size.

Since the time lag Δt can be determined from a scanning speed and the spot interval, it is possible to increase the scanning speed and reduce the measurement time.

The example in which the scanning optical system is configured to scan spots of measurement lights made up of a plurality of lights in the same direction, and the size in a direction perpendicular to a scanning direction of a scanned region for each spot in the scanning is smaller than the sum of the sizes of the spots, has been described above. However, the present invention is not limited to the case where the scan lines almost overlap each other in the direction perpendicular to the scanning direction. Even if the scan lines are shifted from each other within the light diameter, the same effects as the case where the scan lines almost overlap each other can be obtained.

If the fiber collimator 104 is rotated about an optical axis, the second example takes the form same as the first example. Provision of such a rotation mechanism enables measurement with switching between the form of the first example for measurement over a wide range and the form of the second example for accurate measurement of a region almost equal to a light spot size.

### THIRD EXAMPLE

The present example is different from the first and second examples whose scanning speeds and light intervals are fixed. A configuration example including a unit which makes at least one of a light interval and a scanning speed of a scanning optical system variable will be described.

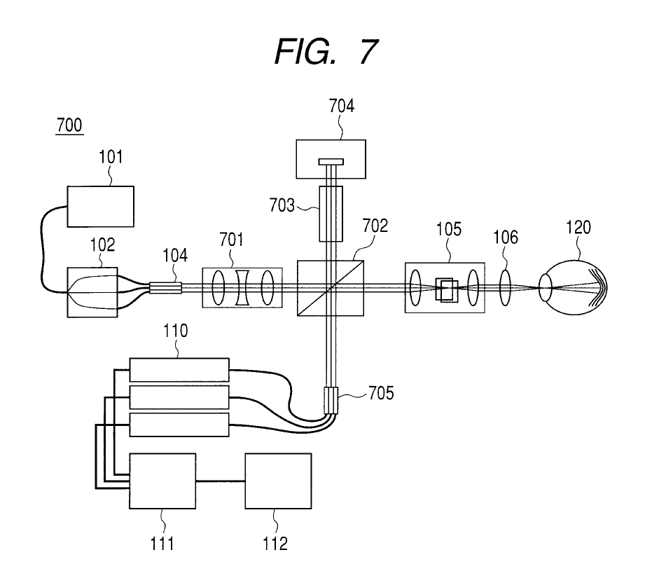

In the present example, an OCT apparatus 700 is made up not of a fiber optical system but of a bulk optical system, as illustrated in FIG. 7. Both optical systems are equally effective.

In the present example, a retina 120 of an eye is selected as an object serving as an object to be measured.

Configurations of from a low coherence light source 101 to a fiber collimator 104 are as in the above examples. However, a configuration of an optical system after collimated lights generated by the fiber collimator 104 enter is made up of a bulk optical system.

The collimated lights pass through a variable zoom optical system 701 which is made up of two convex lenses and one concave lens. Each of the collimated lights are split into measurement lights and reference lights by a beam splitter 702. The measurement lights pass through a scanning optical system 105 and an objective lens 106 and are applied to different points on the retina 120. Lights obtained when the measurement lights are scattered from the retina 120 pass backward through the optical system for measurement lights and are returned to the beam splitter 702.

The reference lights pass through a dispersion compensation glass 703, are reflected by a reference mirror 704, and are returned to the beam splitter 702.

The scattered lights and the reference lights are combined in the beam splitter 702 to generate interfering lights.

The interfering lights enter optical fibers by a fiber collimator 705 and are dispersed by spectroscopic detection sections 110, respectively. Data from the spectroscopic detection sections 110 are processed in a recording section 111 based on the processing flow in FIG. 2 and are displayed on an image display section 112.

The scanning optical system 105 using a galvano mirror is capable of changing a scanning frequency to an arbitrary frequency up to 500 Hz.

In the variable zoom optical system 701, a diameter of the light can vary between 1 and 4 mm.

That is, the magnification can be varied within the range of 1× to 4×. In this case, a light interval varies within the range of 1 to 4 times. Assume that the positions of light spots are adjusted as in FIGS. 5A and 5B such that scan lines overlap as in the second example, a configuration when the light diameter is 1 mm is the same as the configuration in the second example.

If the magnification is 4 times, i.e., if the diameter of the light is 4 mm, a spot size is 5 μm, and a spot interval is 80 μm.

Letting ΔΦl_{stdev}(z,t) be a standard deviation of a detectable phase change, a detectable minimum flow velocity is as follows.

vₘᵢₙ(z)=ΔΦ_{stdev}(z,t) λ₀/(4nΔtΠ) (Expression 4)

A detectable maximum phase change is represented by:

vₘₐₓ(z)=λ₀/(4nΔt) (Expression 5)

Assume that a scanning speed of the scanning optical system 105 and the number of A-line measurement operations are set to be constant in the same manner as in the second example. A time lag Δt can be varied from about 0.21 ms when the spot interval is 320 μm to about 0.05 ms when the spot interval is 80 μm.

Accordingly, letting ΔΦ_{stdev}(z,t)=1°, λ₀=840 nm, and N=1.38 in (Expression 4) and (Expression 5) above, vₘᵢₙ(z)=4.0 μm/s and vₘₐₓ(z)=724 μm/s when Δt=0.21 ms, and vₘᵢₙ(z)=17 μm/s and vₘₐₓ(z)=3,043 μm/s when Δt=0.05 ms. The minimum flow velocity vₘᵢₙ(z) and the maximum phase change vₘₐₓ(z) can vary within the respective ranges.

As described above, the variable zoom optical system 701 can change the flow velocity resolution vₘᵢₙ(z).

This configuration enables proper selection of a spot size. More specifically, it is possible to first roughly know the range of a blood flow velocity in a mode for a spot size of 5 μm (Δt=0.05 ms) and then measure a region including a particular blood vessel in a mode for a spot size of 20 μm (Δt=0.21 ms), for example. Although the time lag Δt is changed by changing the diameter of the light in the present example, the time lag At can also be changed by changing the scanning speed of the scanning optical system 105.

### Other Embodiments

Aspects of the present invention can also be realized by a computer of a system or apparatus (or devices such as a CPU or MPU) that reads out and executes a program recorded on a memory device to perform the functions of the above-described example(s), and by a method, the steps of which are performed by a computer of a system or apparatus by, for example, reading out and executing a program recorded on a memory device to perform the functions of the above-described example(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-114423, filed May 11, 2009, which is hereby incorporated by reference herein in its entirety.

1. An information processing apparatus acquiring moving velocity information in an object comprising:
a scanning optical system for scanning the object with first and second measurement lights;
an optical system which focuses the first and second measurement lights on different spot positions of the object, in which at least part of a region scanned by the first measurement light and a part of a region scanned by the second measurement light overlap each other;
interference signal generating devices which generate interference signals from return lights reflected or scattered by the object and the reference lights reflected by a reference mirror; and
a signal processing device which calculates a variation in phase using the interference signals from different measurement lights and computes a moving velocity in the object based on the variation in phase.

2. The information processing apparatus according to claim 1, in that
the scanning optical system is adapted to scan spots of the measurement lights made up of the first and second lights in a same direction, and
a size of a scanned region for the spots in a direction perpendicular to a scanning direction in the scanning is smaller than the sum of sizes of the spots.

3. The information processing apparatus according to claim 1, comprising a unit which makes at least one of an interval between the first and second measurement lights and a scanning speed of the scanning optical system variable.

4. The information processing apparatus according to claim 1, wherein at least a part of a scan line of the first measurement light and at least a part of a scan line of second measurement light overlap each other.

5. The information processing apparatus according to claim 1, wherein the variation in phase is calculated using the interference signals by the return lights from substantially same spot position at which the first and second measurement lights are irradiated at different times.

6. The information processing apparatus according to claim 1, wherein the object is a retina of the eye, and the moving velocity in the object is a blood flow velocity.

7. The information processing apparatus according to claim 1, wherein a tomographic image of the object obtained using the interference signals and the moving velocity in the object are displayed on an image display section.

8. An information processing method comprising: irradiating a first measurement light and a second measurement light at substantially same spot position of an object at different times;
obtaining a first interference signal and a second interference signal in which, a first and a second measurement lights from the substantially same spot of the object, and a first and a second reference lights respectively correspond to the first and the second measurement lights, respectively interfere each other; and calculating a moving velocity in the object based on a variation in phase between the first and the second interference signals.

9. The information processing method according to claim 8, wherein at least a part of a scan line of the first measurement light and at least a part of a scan line of second measurement light overlap each other.

10. The information processing method according to claim 8, wherein the object is a retina of the eye, and the moving velocity in the object is a blood flow velocity.

11. The information processing method according to claim 8, wherein a tomographic image of the object obtained using the interference signals and the moving velocity in the object are displayed on an image display section.
